(19) United States
(12) Patent Application Publication
(10) Pub. No.: US 2006/0227728 A1
(43) Pub. Date: Oct. 12, 2006

(54) Method software product and device for signalling bearer channel modifications by means of a sip protocol

(76) Inventor: Thomas Baumann, Holzkirchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/568,734

(22) PCT Filed: Jun. 4, 2004
(86) PCT No.: PCT/EP04/51028

§ 371 Date: Feb. 17, 2006

(30) Foreign Application Priority Data
Aug. 18, 2003 (EP) 03018586.2

(51) Int. Cl. H04L 12/16; H04L 12/66

(52) U.S. Cl. 370/260; 370/352

(57) ABSTRACT

A SIP protocol is extended with at least one protocol element which is used for displaying a cause for bearer channel modification, thereby eliminating the necessity for the deductive regeneration of the cause on the basis of the modification of a transmitted bearer channel.

### CROSS REFERENCE TO RELATED APPLICATIONS

This application is the US National Stage of International Application No. PCT/EP2004/051028, filed Jun. 4, 2004 and claims the benefit thereof. The International Application claims the benefits of European application No. 0301856.2 EP filed Aug. 18, 2003, both of the applications are incorporated by reference herein in their entirety.

### FIELD OF INVENTION

The present invention relates to signaling bearer channel modifications via SIP protocol.

### BACKGROUND OF INVENTION

In the past two major types of network for the transmission of information have emerged. Packet-oriented (data) networks and circuit-oriented (speech) networks. In the course of the convergence of these two network types, convergent (voice-data) networks have emerged. The convergence of these different network types has produced hybrid networks, in which the object of the present invention can be used to particularly good advantage.

Circuit-oriented networks—also called voice networks or telephone networks—are designed for the transmission of (speech) information, also referred to by experts as voice, call or session information, in a continuous stream. The information is usually transferred in this case with high service quality and security For example a minimal—e.g. <200 ms—delay without fluctuations in the delay jitter is important for speech, since speech requires a continuous flow of information for reproduction in the receive device. A loss of information can therefore not be compensated for by retransmission of the information not yet transferred and usually leads in the receive device to audibly perceptible interference (e.g. clicking, distortion, echo, silence). Experts also refer to the transfer of speech in general terms as a realtime service.

Packet-oriented networks—also called data networks—are designed for the transfer of what experts refer to as data packet flows. In this case a high quality of service does not usually have to be guaranteed. Without guaranteed quality of service the transfer of the data packet flows is undertaken for example with varying delays, since the individual data packets of the data packet flows are usually transferred in the order in which they enter the network, i.e. the delay jitter is all the greater, the more packets there are to be transferred by a data network. Among experts the transfer of data is therefore also referred to as a non-realtime service.

The packets are normally distinguished depending on the type of packet-oriented network. They can for example be embodied as Internet, X.25 or Frame Relay packets, but also as ATM cells. They are sometimes also referred to as messages, particularly when a message is transferred in a packet.

A known data network is the Internet. Because of the Internet Protocol IP used on it, this is sometimes also referred to as an IP network, with this term basically having a broad meaning and covering all networks in which the IP protocol is used. The Internet is designed as an open (international) data network with open interfaces for connection of (mostly local and regional) data networks of different manufacturers. It provides a non-proprietary transport platform.

Connections are communication links between at least two users for the purpose of a—mostly mutual, i.e. bidirectional—transfer of information. The subscriber initiating the connection is usually called the ‘A-subscriber’. A subscriber connected to an A-subscriber by a connection is called the ‘B-subscriber’. In a connectionless network connections represent the at least on a logical abstract level unique relationship between A- and B-subscriber, i.e. in accordance with this viewpoint, the connectionless flows in the Internet represent for example logically abstracted connections (e.g. A-subscriber=Browser and B-subscriber=Web Server). In a connection-oriented network connections also represent at the physical level unique paths through the network along which the information will be transferred.

In the course of the convergence of voice and data networks voice transmission services and increasingly also wider band services such as the transfer of moving image information for example are being implemented in packet-oriented networks, i.e. the transfer of the real-time services usually transferred in a circuit-oriented manner is undertaken in a convergent network—also called a voice data-network—in a packet-oriented manner, i.e. in packet flows. These are also called real-time packet flows. The transfer of voice information over a packet-oriented IP network is in this case also referred to as ‘VoIP’ (Voice over IP).

A number of distributed architectures for voice data-networks are described in the international standardization bodies IETF (Internet Engineering Task Force) and ITU (International Telecommunications Union). The common factor in all such networks is that the call control level and the resource control level are strictly separated from each other functionally and are mostly even realized on different hardware platforms.

The call control level in such cases includes at least one (optional) call controller, to which some of the assigned functions are as follows:
Address Translation: Conversion of E.164 telephone numbers and other alias addresses (e.g. host names) to transport addresses (e.g. Internet addresses).
Admission Control (optional): Basic authorization checking as to whether and to what extent (e.g. VoIP-capable) devices may use the communication network.
Bandwidth Control (optional): Administration of transmission capacities.
Zone Management: Registration of (e.g. VoIP-capable) devices and provision of the above functions for all devices registered with the call controller.

Optionally the following functions can also be assigned to a call controller:
Call Control Signaling: All signaling messages are switched by at least one call controller, i.e. all devices send and receive signaling messages only via the call controller. A direct exchange of signaling messages between the devices is forbidden.
Call Authorization: Authorization check for incoming and outgoing calls.
Bandwidth Management: Control of the permitted number of devices which may simultaneously use the communication network.
Call Management: Administration of a list of existing calls, in order to enable a busy signal to be created for example if this cannot be created by the device itself.
Alias Address Modification: Returning a modified alias address, typically with an H.225.0 message ACF (Admission Confirmation). The end point must use this address on connection setup.
Dialed Digit Translation: Translation of the dialed digits into an E.164 telephone number or a number from a private numbering scheme.

Examples of call controllers are represented by the ‘Gatekeeper’ proposed by the ITU in the H.323 standard family or the ‘SIP Proxy’ proposed by the IETF. If a larger communication network is divided up into a number of domains—also called ‘zones’, a separate call controller can be provided in each domain. A domain can also be operated without a call controller. If there is provision for a number of call controllers in one domain, only one of these should be activated. From the logical standpoint a call controller should be seen as separate from the devices. Physically however it does not have to be realized in a separate call controller device, but can also be provided in each end point of a connection (for example embodied as an H.323 or SIP end point, a terminal, media gateway, multipoint control unit) or also of a device primarily embodied for program-controlled data processing (for example host, PC, server). A physically distributed implementation is also possible.

An alternate example is a Media Gateway Controller, to which the optional functions call control signaling and call management are usually assigned. Furthermore the assignment of a signaling conversion function for converting different (signaling) protocols is conceivable, said function being required for example at the boundary between two different networks which are combined into a hybrid network.

The resource control level comprises at least one resource controller, to which some of the functions assigned are as follows:
Capacity Control: Control of the traffic volume routed to the communication network by packet flows, e.g. by controlling the transmission capacity of individual packet flows.
Policy Activation (optional): if necessary reserve resources in the communication network for a prioritized packet flow for transfer of this flow.
Priority Management (optional): Set, check and if necessary correct priority flags in the packets in accordance with the priority of their packet flows, if the packets are already identified with priorities.

The resource controller is also referred to as a ‘Policy Decision Point (PDP)’. It is realized for example within edge routers—also called edge devices, access nodes or, for assignment to an Internet Service Provider (ISP), also Provider Edge Routers (PER). These edge routers can also be embodied as media gateways to other networks to which the voice-data networks will be connected. These media gateways are then connected to both the voice-data network and to the other networks and are used internally for conversion between the different (transfer) protocols of the various networks. The resource controller can also be embodied only as a proxy and forward resource controller-relevant information to a separate device on which the relevant information corresponding to a function of the resource controller will be processed.

Usually a plurality of messages are sent for coordinating the two levels, which merely serve to coordinate the components involved but not to transfer the actual information between the terminals. This information transferred with the messages is usually referred to as signaling information, signaling data or simply as signaling. The term is taken to have a wide meaning in this case. Thus for example, as well as the signaling messages there are also the messages in accordance with the RAS, the messages in accordance with the ITU standard H.245 for control of user channels of existing calls, as well as all further similarly embodied messages. The signaling protocol for call set up and call release according to the ITU is for example described in standard H.225.0, according to the IETF in the RFC2543 (“SIP: Session Initiation Protocol”) or its revisions RFC2543 to 0x or RFC3261. The “actual information” to distinguish it from the signaling, is also referred to as user information, payload, media information, media data or simply media. Communication links which are used for the transfer of signaling are also referred to below as signaling connections. The communication relationships used for the transfer of user information are for example referred to as a voice connection, a user channel connection or—in simple terms—user channel, a bearer channel or simply bearer. In this context the term out-of-band or outband is taken to mean the transfer of information on another path/medium than that provided in the communication network for the transfer of signaling and user information. This especially includes a local configuration of devices which is undertaken for example with a local control device. By contrast in-band information is transferred on the same path/medium, if necessary logically separated from the signaling and user information considered.

The basic interaction between the two levels will be explained on the basis of a call setup between two VoIP devices embodied as subscriber terminals. In this case the initial assumption is that of a homogeneous voice-data network.

Within the actual call setup or partly also before it in time, the steps authentication, authorization and (start of the) accounting are executed when a terminal dials into the IP network (for example via an Internet Service Provider). This so-called ‘AAA’ functionality is usually realized by accessing a subscriber database in which all subscribers with their identifications, passwords, rights etc are stored. This access is slow and comparatively complex. In today's “best effort” IP networks this AAA process is normally undertaken once when the user is dialing in. A further authentication is undertaken when a call controller is used if the terminal registers with the call controller of the Internet Service Provider. According to ITU standard H.323 this authentication or registration of a terminal with the assigned gatekeeper is executed in accordance with the RAS (Registration, Admission, Status) protocol which is described in ITU standard H.225.0.

The actual call setup normally begins in a first step by the terminals of the subscribers exchanging their capabilities (e.g. list of the codecs supported), in order to determine the required resources (e.g. bandwidth) and the required QoS (e.g. delay, jitter). The terminals are for example embodied for voice telephony as IP telephones or VoIP client software, for online video one of the terminals could be a content or application server, in the network of the Internet Service Provider (ISP) for example.

The signaling messages are exchanged either directly between the terminals or are switched by a call controller. In this case for each call for each terminal and for each direction of transmission the variants to be used are determined individually. The first variant is also referred to in H.323 terminology as ‘Direct Endpoint Call Signaling’ and the second as ‘Gatekeeper Routed Call Signaling’. With Direct Endpoint Call Signaling copies of selected signaling messages can be transferred to a call controller if necessary so that with this variant too a call controller frequently has knowledge about the resources and QoS requirements agreed between the terminals. These requirements are however not actively influenced or verified by the device itself.

Alternatively the SIP protocol can also be used, and can be used both for IP devices and also between media gateway controllers. In the second case the SIP protocol is called SIP T (SIP for Telephones) which is described in the RFC3372 standard. If a call is set up with the aid of the SIP protocol, a description of the bearer is usually exchanged between the two sides of the connection. The Session Description Protocol (SDP) in accordance with the RFC2327 standard can be used for this. One place where this usage is described is in the RFC3264 standard: “An Offer/Answer Model with the Session Description Protocol (SDP)”. The following bearer data is of primary importance here:
IP address of the bearer connection
RTP/UDP port of the bearer connection (depending on whether voice or data is being transmitted)
Codec(s) which are (can be) used for the voice or data transmission
Stream mode of the bearer connection

In a second optional step the resources and QoS requirements agreed in this manner can be transferred directly from the terminals of the subscribers to their assigned resource controllers. After the resources and QoS requirements have been checked the resource controller returns a confirmation (or rejection) to the terminal.

In a third, likewise optional step, a policy is activated in the edge router and if necessary further routers in the network by which these routers check and guarantee that the traffic caused by the terminal lies within the boundaries which were specified in the requirement. An example of this type of reservation mechanism is RSVP (resource ReSerVation Protocol).

In summary the function split between the two levels can be described as only the functions which are required for transfer of user information being assigned to the resource control level whereas the call controller level includes the intelligence for controlling the resource control level. In other words: The devices of the resource control level where possible do not possess any network control intelligence and as a consequence can be realized on separate hardware platforms especially advantageously from the economic standpoint. This is a particularly great advantage because of the higher numbers installed at this level compared to the call control level.

### SUMMARY OF INVENTION

Both in convergent voice-data networks and also in hybrid networks which for example are formed by combining a convergent voice-data network with a conventional circuit-oriented voice network, new technical problems arise for the transfer of information, especially packet flows in real time, because of the new or different technologies which are used in the relevant network types.

An object of the invention is to recognize at least one of these problems and to improve the prior art by specifying at least one solution.

The invention poses the question of whether, after the setup of a call using the SIP protocol, all features can continue to be used which are currently known from telephony. In many of these features modifications of the IP bearer are necessary in this case, e.g.:
Switchover of the voice connection to data transmission for fax and modem applications
Bearer Redirection (e.g. for the redirection of the connection on an announcement)
Renegotiation of the voice/data codec during the call (Mid Call Codec Negotiation)
Call Hold and Call Retrieve

All the features specified above result in a new exchange of the bearer description in the form of an SDP session, which is transported in an SIP/SIP_T:Re-INVITE message or the associated SIP/SIP_T Response. In this case the cause of the bearer modification is not explicitly transmitted either in the SIP protocol or in the SDP Session, but must be regenerated on the receiving side from the SDP data, with only the bearer modification being displayed. This regeneration is not however always uniquely possible. For example there can be problems in the following cases:
if the codec of a voice connection is changed, this can be a codec switchover for fax/modem, a switchover to a new voice codec, or also a renegotiation voice codec during the call (Mid Call Codec Negotiation).
If a number of features are combined it is sometimes no longer possible to determine on the basis of the new received SDP session which features have been combined. An SDP session for Bearer Redirect for example looks exactly like an SDP session which is sent for simultaneous Call Retrieve and Bearer Redirect.

Without unique regeneration of the cause no informative information can thus be provided on the receiving side (e.g. on the display of a telephone or at the user interface of a software telephone client) as to which feature has just been activated by the sending side.

A solution to this problem underlying the invention is specified in the claims.

A plurality of benefits is connected with this solution:
By transferring the cause of the bearer modification an unrestricted use of the widest variety of telephony service features is made possible.
The previous partly very expensive, deductive determination of the cause of the bearer modification on the basis of the bearer modification transferred is dispensed with.
The (unique) specification of the cause(s) of the bearer modification enables the features activated by the sending side to be determined and displayed even when they cannot be deductively regenerated from the bearer modification.

Further advantageous embodiments of the invention are produced by the subordinate and related claims.

The interworking between the protocols SIP/SIFT and the protocols BICC CS2/ISUP+ (see ITU-T Recommendation Q.1902.x, Bearer Independent Call Control Protocol CS-92) is basically simplified if the protocol element is embodied as an action parameter with the following values: connect-backward, connect-forward, connect-forward-no-notification, connect-forward-plus-notification, connect-forward-no notification-plus-selected codec, connect forward-plus-notification-plus-selected codec, connected, switched, selected-codec, modify-codec, successful-codec-modification, codec-modification-failure, mid-call-codec-negotiation, modify-to-selected-codec-information, mid-call-codec-negotiation-failure, redirect-backwards-request, redirect-forwards-request, redirect-bearer-release-request, proceed, redirect-bearer-release-complete, redirect-cut-through-request, redirect-bearer-connected-indication, redirect-failure, remote-hold, remote-hold-ack, remote-retrieval, remote-retrieval-ack, because the action parameter can in this way be easily converted into the BICC CS2/ISUP+ information elements “Action Indicator” and “Bearer Redirection Indicators”.

### BRIEF DESCRIPTION OF THE DRAWINGS

The invention is explained below on the basis of further exemplary embodiments which are also shown in the Figures. The Figures show:

FIG. 1 an arrangement for execution of the method in accordance with the invention with a hybrid communication network, consisting of a packet-oriented, integrated voice-data network and a circuit-oriented voice network which are connected by intermediate media gateways and media gateway controllers as well as to end points of an information transfer

FIG. 2 a flowchart in which an embodiment of the invention is illustrated as an example

### DETAILED DESCRIPTION OF INVENTION

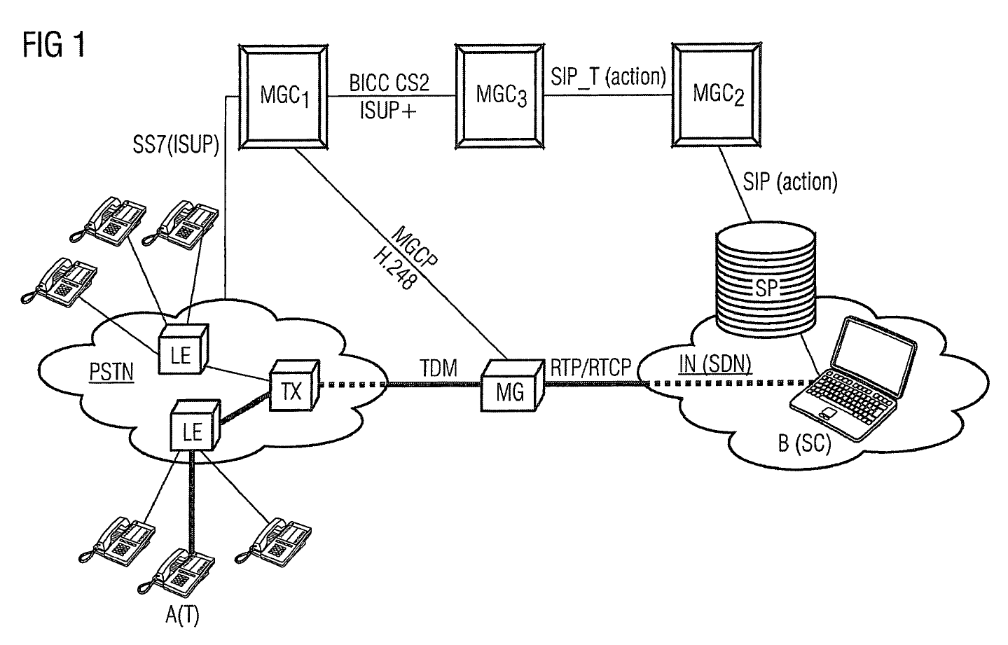

FIG. 1 shows a typical arrangement for executing the method in accordance with invention. It comprises a circuit-oriented network PSTN and a communication network IN, which is preferably embodied as an integrated voice-data network SDN. The two networks PSTN, IN are combined into one hybrid network. Network IN is preferably embodied as an IP network (e.g. the Internet) and includes an SIP proxy SP as its call controller.

The circuit-oriented bearer TDM is merged with the packet-oriented bearer RTP/RTCP through intermediate media gateways MG for conversion between different network-specific user channel technologies RTP/RTCP (Real Time [Control] Protocol) and TDM (Time Division Multiplex), the signaling SS7 of the network PSTN is merged with the signaling SIP of the network IN through intermediate Media Gateway Controllers MGC1-3 for converting between different network-specific signaling protocols SIP (Session Initiation Protocol). In this case a protocol BICC CS2/ISUP+ is used between the controllers MGC1 and MGC3 and a protocol SIP_T (SIP for Telephones) between the controllers MGC3 and MGC2.

The media gateway MG is controlled by the controller MGC1 assigned to it by a—preferably internationally standardized—protocol, e.g. MGCP (Media Gateway Control Protocol) or H.248. It is usually realized as a separate unit which runs on a different physical device/hardware platform to the controller MGC.

A subscriber A is connected to the network PSTNA with the aid of a conventional telephone T, a subscriber B to the network IN with the aid of an SIP-enabled telephone—e.g. an SIP client SC realized in software, between which an end-to-end user connection TDM, RTP/RTCP is created as a bearer.

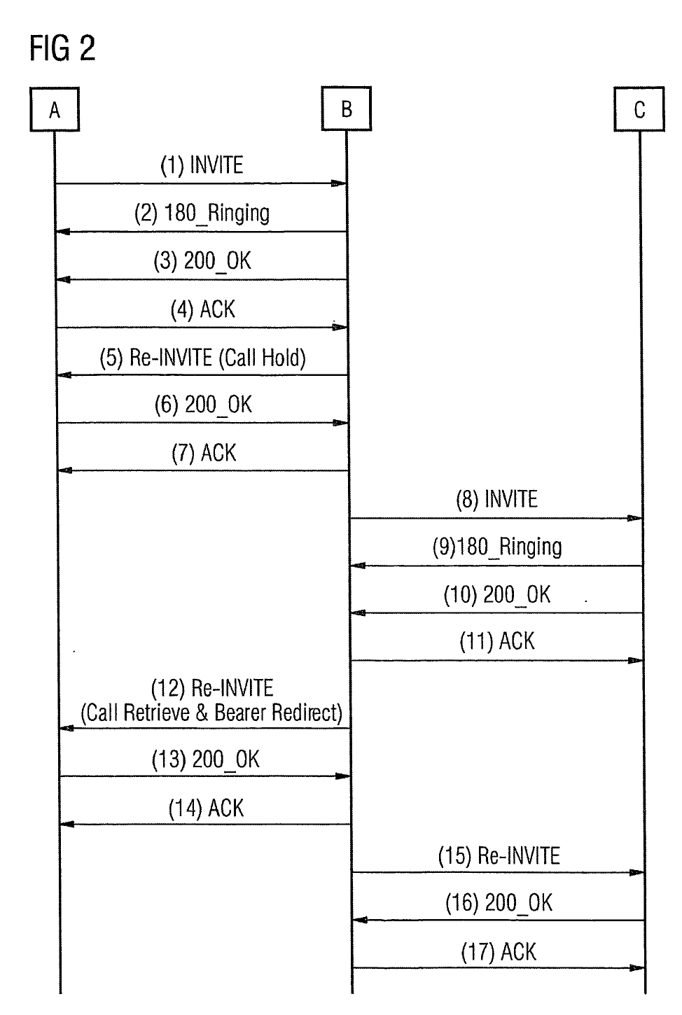

FIG. 2 shows the sequence of SIP messages (1)-(4) for setting up a bearer between two SIP clients A, B and of messages (5)-(17) for modification of the bearer by forwarding the call from the SIP client B to an SIP client C, in which the messages (6), (12), (13), (15) and (16) are embodied in accordance with an inventive SIP protocol.

It should be stressed that the embodiments of the invention shown in these figures, despite their highly detailed presentation in some cases of concrete network scenarios, are merely typical examples and are not to be seen as restrictive. It is clear to the person skilled in the art that the invention can be used in all conceivable network configurations, especially other interworking scenarios as well as further packet-oriented networks, for example Intranet, Extranet, a local network (Local Area Network—LAN) or a corporate network embodied as a virtual private network (VPN) for example.

In the exemplary embodiment shown in FIG. 1 the SIP protocol as well as its derivative SIP_T will be used in a complex, hybrid network scenario in which the network signaling will be converted a plurality of times between the protocols SIP, SIP_T, BICC CS2/ISUP+, SS7 (ISUP:). In this case the controller MGC3 converts between the protocol BICC CS2/ISUP+ and the inventive SIP_T protocol including at least one inventive protocol element—especially parameter action—for displaying the cause of modifications to the bearer TDM, RTP/RTCP.

To this end an SDP session is transmitted in selected SIP_T messages in the message body along with ISUP MIME content (mixed content; see RFC2046 “Multipurpose Internet Mail Extensions (MIME) Part Two: Media Types”, and RFC3204 “MIME media types for ISUP and QSIG Objects”), in the SDP body of which a “Content-Disposition” header field according to RFC2183 is embedded, which in each case includes at least one inventive protocol element for transfer of the causes(s) of a bearer modification. The “disposition-type” of this header Field is set to “session”. In addition, a new “disposition-parameter” named “action” for specifying the cause of the bearer modification is introduced as a new protocol element and embedded into the “Content-Disposition” header field.

For combination of a number of causes/features a number of “action” parameters can be transmitted in one “Content-Disposition” header field, in compliance with ITU T Standard Q.765.5 (Signaling System No. 7—Application Transport mechanism for Bearer Independent Call Control), which is used in accordance with ITU-T Standard Q.1902.x BICC CS2 (bearer independent call control—capability set 2) e.g. between call controllers MGC, the range of values of the “action” parameter is as follows: connect-backward, connect-forward, connect-forward-no-notification, connect-forward-plus-notification, connect-forward-no notification-plus-selected codec, connect forward-plus-notification-plus-selected codec, connected, switched, selected-codec, modify-codec, successful-codec-modification, codec-modification-failure, mid-call-codec-negotiation, modify-to-selected-codec-information, mid-call-codec-negotiation-failure, redirect-backwards-request, redirect-forwards-request, redirect-bearer-release-request, proceed, redirect-bearer-release-complete, redirect-cut-through-request, redirect-bearer-connected-indication, redirect-failure, remote-hold, remote-hold-ack, remote-retrieval, remote-retrieval-ack.

A typical inventive “Content-Disposition” header field appears in this example as follows (the inventive protocol element is highlighted in bold type):

```
Content-Disposition: session
  ; action=remote-retrieval
  ; action=redirect-forwards-request
```

Because of the invention there is the great advantage that the BICC CS2/ISUP+ information elements “Action indicator” and “Bearer Redirection Indicators” can be very simply equipped with informative values.

As a further exemplary embodiment of the invention a bearer modification between three subscribers A, B, C, who are all embodied as SIP Clients SC, is described. The execution sequence of this scenario is shown in FIG. 2. For simplified understanding of the invention FIG. 2 only shows SIP clients SC and SIP proxy server SP is omitted.

In this example a connection/call is first set up between the SIP clients A and B—messages (1)(4). Subsequently the SIP Client B places the call on hold—messages (5)-(7)—and then calls the SIP client C—messages (8)-(1 1). After this call the SIP client B sends a “Re-INVITE” message (12) to SIP client A, with which he simultaneously cancels the call hold (Call Retrieve) and redirects the outgoing call stream from the SIP client A to the SIP client C (bearer redirect)—messages (12)(14). Finally the SIP client B sends a “Re-INVITE” message (15) to SIP client C, with which he redirects the outgoing call stream from SIP client C to SIP client A (Bearer Redirect). The end result is a call transfer from SIP for 3 to SIP client C. SIP client A can now speak to SIP client C.

Subsequently the messages (1)-(17) are displayed, with these dispensing with the presentation of “Via” header fields since these are transparent for the SDP body content of the SIP messages. In this case an SDP session is transported in an SIP message as MIME Message Body in accordance with RFC2045. In the case of SDP content of the SIP message body with the following SIP header fields is specified in this example:
“MIME-Version”:

fixed at “MIME-Version: 1.0” (=RFC2045)—can optionally also be omitted.
“Content-Length”: specifies the length of the overall message body.
“Content-Type”: specifies the type of the content in the form of a Media Type and Media Subtype. In the case of SDP the Content Type appears as follows:
   media type=“application”
   media subtype=“SDP”

A typical message SIP; Re-INVITE with SDP thus appears as follows:

INVITE sip: “E.164(B-Tln)”@“IP-Addr(B-Tln)”;user=phone SIP/2.0
From: <sip:“E.164(A-Tln)”@“IP-Addr(A-Tln)”;user=phone>
To: <sip:“E.164(B-Tln)”@“IP-Addr(B-Tln)”;user=phone>
Call-ID: a84b4c76e66710
CSeq: 8348 INVITE
Contact: <sip:“E.164(A-Tln)”@“IP-Addr(A-Tln)”;user=phone>

| | |
|---|---|
| MIME-Version: | 1.0 |
| Content-Type: | application/SDP |
| Content-Length: | 166 |

v=0
o=hiQ9200 2890844526 2890844527 IN IP4 “IP-Addr(A-Tln)”
s=
c=IN IP4 aaa.bb.cc.dd
t=0 0
m=audio 2673 RTP/AVP 4
a=rtpmap:4 G723/8000
a=sendrecv

For transmission of the cause of a bearer modification the “Content-Disposition” header field in accordance with RFC2183 is used for SDP for example of which the syntax can correspond to that of the previous exemplary embodiment.

A typical “Content-Disposition” header field, which is sent because of a bearer redirection therefore appears in the above SIP: Re-INVITE message, embedded in an SDP protocol (the protocol element in accordance with the invention is highlighted in bold type):

[MIME-Version: 1.0]
Content-Type: application/SDP
Content-Disposition: session
; action=redirect-forwards-request
Content-Length: xxx

For the exemplary embodiment the following messages (1)-(17) are therefore produced, with the inventive protocol elements being highlighted accordingly in the messages (6), (12), (13), (15) and (16):

Message (1): 8348 INVITE Client A ->Client B

INVITE sip:ClientB@gmx.com SIP/2.0
From: sip:ClientA@munichnet.com;tag=1c24841
To: sip:ClientB@gmx.com
Call-ID: call-973574144@munichnet.com
CSeq: 1 INVITE
Contact: <sip:ClientA@pc43.munichnet.com>
Content-Type: application/sdp
Content-Length: 161
o=ClientA 2890844526 2890844526 IN IP4 pc43.munichnet.com
S=
c=IN IP4 192.0.2.101
t=0 0
m-audio 49172 RTP/AVP 8
a=rtpmap:8 PCMA/8000
a=rtpmap:4 G723/8000
   Message (2): 180 Ringing Client B->Client A
SIP/2.0 180 Ringing
From: sip:ClientA@munichnet.com;tag=1c24841 To:
sip:ClientB@gmx.com;tag=0da40dd4-81553525 Call-ID: call-
973574144@munichnet.com
CSeq: 1 INVITE
Contact: <sip:ClientB@sv71.gmx.com>
Content-Length: 0
   Message (3): 200 OK Client B->Client A
SIP/2.0 200 OK
From: sip:ClientA@munichnet.com;tag=1c24841 To:
sip:ClientB@gmx.com;tag=0da40dd4-81553525 Call-ID: call-973574144@munichnet.com
CSeq: 1 INVITE
Contact: <sip:ClientB@sv71.gmx.com>
Content-Type: application/sdp
Content-Length: 124
v=0
o=ClientB 4770 4770 IN IP4 sv71.gmx.com s=
c=IN IP4 178.224.67.133
t=0 0
m=audio 49172 RTP/AVP 8
a-rtpmap:8 PCMU/8000
   Message (4): ACK Client A->Client B
ACK sip:ClientB@v71.gmx.com SIP/2.0
From: sip:ClientA@munichnet.com;tag=1c24841
To: sip:ClientB@gmx.com;tag=0da40dd4-81553525
Call-ID: call-973574144@munichnet.com
CSeq: 1 ACK
Content-Length: 0
   Message (5): Re-1 INVITE Client B->Client A
INVITE sip:ClientA@pc43.munichnet.com SIP/2.0
From: sip:ClientB@gmx.com;tag=0da40dd4-81553525
To: sip:ClientA@munichnet.com;tag=1c24841
Call-ID: call-973 5741 44@munichnet.com
CSeq: 2 INVITE
Contact: <sip:ClientB@sv71.gmx.com>
Content-Type: application/sdp
Content-Disposition: session;

action=remote-hold
Content-Length: 128
v=0
o=ClientB 4770 4771 IN IP4 sv71.gmx.com
S=
c=IN IP4 0.0.0.0
t=0 0
a=sendonly
m=audio 49172 RTP/AVP 8
a=rtpmap:8 PCMU/8000
   Message (6): 200 OK Client A->Client B
SIP/2,0 200 OK
From: sip:ClientB@gmx.com;tag=0da40dd4-8 1553525
To: sip:ClientA@munichnet.com;tag=1c24841
Call-ID: call-973 5741 44@munichnet.com
CSeq: 2 INVITE
Contact: <sip:ClientA@pc43.munichnet.com>
Content-Type: application/sdp
Content-Disposition: session;
action=remote-hold-ack
Content-Length: 155
v=0
o=ClientA 2890844526 2890844527 IN IP4 pc43.munichnet.com
s=
c=IN IP4 0.0.0.0
t=0 0
a=recvonly
m=audio 49172 RTP/AVP 8
a=rtpmap:8 PCMA/8000
   Message (7): 1 ACK Client B->Client A
ACK sip:ClientA@pc43.munichnet.com SIP/2.0
From: sip:ClientB@gmx.com;tag=0da40dd4-81553525
To: sip:ClientA@munichnet.com;tag=1c24841
Call-ID: call-973574144@munichnet.com
CSeq: 2 ACK
Content-Length: 0
   Message (8): INVITE Client B->Client C
INVITE sip:ClientC@tomnet.de SIP/2.0
From: sip:ClientB@gmx.com;tag=0da40dd4-81553526
To: sip:ClientC@tomnet.de
Call-ID: call-6789@gmx.com
CSeq: 10 INVITE
Contact: <sip:ClientB@sv71.gmx.com>
Content-Type: application/sdp
Content-Length: 122
v=0
o=ClientB 5612 5612 IN IP4 sv71.gmx.com
s=
c=IN IP4 178.224.67.133
t=0 0
m=audio 3460 RTP/AVP 8
a=rtpmap:8 PCMU/8000
   Message (9): 180 Ringing Client C->Client B
SIP/2.0 180 Ringing
From: sip:ClientB@gmx.com;tag=0da40dd4-81553526
To: sip:ClientC@tomnet.de;tag=6545b243a
Call-ID: call-6789@gmx.com
CSeq: 10 INVITE
Contact: <sip:ClientC@nb23.tomnet.de>
Content-Length: 0
   Message (10): 200 OK Client C->Client B
SIP/2.0 200 OK
From: sip:ClientB@gmx.com;tag=0da40dd4-81553526
To: sip:ClientC@tomnet.de;tag=6545b243a
Call-ID: call-6789@gmx.com
CSeq: 10 INVITE
Contact: <sip:ClientC@nb23.tomnet.de>
Content-Type: application/sdp
Content-Length: 127
o=ClientC 293845 293845 IN IP4 nb23.tomnet.DE
s=
c=IN IP4 27.159.111.76
t=0 0
m=audio 8275 RTP/AVP 8
a=rtpmap:8 PCMU/8000
   Message (11): ACK Client B->Client C
ACK sip:ClientC@tomnet.de SIP/2.0
From: sip:ClientB@gmx.com;tag=0da40dd4-81553526
To: sip:ClientC@tomnet.de;tag=6545b243a
Call-ID: call-6789@gmx.com
CSeq: 10 ACK
Content-Length: 0
   Message (12): Re-INVITE Client B->Client A
INVITE sip:ClientA@pc43.munichnet.com SIP/2.0
From: sip:ClientB@gmx.com;tag=0da40dd4-81553525
To: sip:ClientA@munichnet.com;tag=1c24841
Call-ID: call-973574144@munichnet.com
CSeq: 3 INVITE
Contact: <sip:ClientB@sv71.gmx.com>
Content-Type: application/sdp
Content-Disposition: session;
action=remote-retrieval;
action=redirect-forwards-request
Content-Length: 134
v=0
o=ClientB 4770 4772 IN IP4 sv71.gmx.com
S=
c=IN IP4 27.159.111.76
t=0 0
a=sendrecv
m=audio 8275 RTP/AVP 8
a=rtpmap:8 PCMU/8000
   Message (13): 200 OK Client A->Client B
SIP/2.0 200 OK
From: sip:ClientB@gmx.com;tag=0da40dd4-81553525
To: sip:ClientA@munichnet.com;tag=1c24841
Call-ID: call-973574144@munichnet.com CSeq: 3 INVITE
Contact: <sip:ClientA@pc43.munichnet.com>
Content-Type: application/sdp
Content-Disposition: session;

action=remote-retrieval-ack;

action=redirect-bearer-connected-indication
Content-Length: 172
v=0
o=ClientA 2890844526 2890844528 IN IP4 pc43.munichnet.com
s=
c=IN IP4 192.0.2.101
t=0 0
a=sendrecv
m=audio 49172 RTP/AVP 8
a=rtpmap:8 PCMA/8000
   Message (14): ACK Client B->Client A
ACK sip:ClientA@pc43.munichnet.com SIP/2.0
From: sip:ClientB@gmx.com;tag=0da40dd4-81553525
To: sip: ClientA@munichnet.com;tag=1c24841
Call-ID: call-973574144@munichnet.com
CSeq: 3 ACK
Content-Length: 0
   Message (15): Re-INVITE Client B->Client C
INVITE sip:ClientC@nb23.tomnet.de SIP/2.0
From: sip:ClientB@gmx.com;tag=0da40dd4-81553526
To: sip:ClientC@tomnet.de
Call-ID: call-6789@gmx.com
CSeq: 11 INVITE
Contact: <sip:ClientB@sv71.gmx.com>
Content-Type: application/sdp
Content-Disposition: session;

action=redirect-forwards-request
Content-Length: 120
v=0
o=ClientB 5612 5613 IN IP4 sv71.gmx.com
s=
c=IN IP4 192.0.2.101 t=0 0
m=audio 49172 RTP/AVP 8
a=rtpmap:8 PCMU/8000
   Message (16): 200 OK Client C->Client B
SIP/2.0 200 OK
From: sip:ClientB@gmx.com;tag=0da40dd4-81553526
To: sip:ClientC@tomnet.de;tag=6545b243a
Call-ID: call-6789@gmx.com
CSeq: 11 INVITE
Contact: <sip:ClientC@nb23.tomnet.de>
Content-Type: application/sdp
Content-Disposition: session;

action=redirect-bearer-connected-indication
Content-Length: 127
v=0
o=ClientC 293845 293846 IN IP4 nb23.tomnet.DE
S=
c=IN IP4 27.159.111.76 t=0 0
m=audio 8275 RTP/AVP 8
a=rtpmap:8 PCMU/8000
   Message (17): ACK Client B->Client C
ACK sip:ClientC@nb23.tomnet.de SIP/2.0
From: sip:ClientB@gmx.com;tag=0da40dd4-81553526
To: sip:ClientC@tonmet.de;tag=6545b243a
Call-ID: call-6789@gmx.com
CSeq: 11 ACK
Content-Length: 0
   It is clear to the person skilled in the art that the invention can of course not just be used in the scenarios described but is universally applicable in all scenarios in which the SIP or SIP_T protocol is used. In particular use in the following scenarios is conceivable:
   VoIP Trunking Subscriber <-> VoIP Trunking Subscriber with the protocol SIP_T for signaling between controllers MGC
   SIP Client <-> VoIP Trunking Subscriber
   SIP Client <-> Access Gateway
   SIP Client <-> H.323 Subscriber
   SIP Client <-> VoDSL Subscriber (connected via an Integrated Access Device IAD or a Customer Premises Gateway CPG)
   SIP Client <-> SIP Client

Finally it should be pointed out that the description of the components relevant to the invention of the communication network is basically not to be seen as restrictive. For the appropriate person skilled in the art it is especially evident that terms such as application, client, server, gateway, controller, etc. are to be understood as functional and not as physical terms. Thus for example the end points A, B can also be implemented partly or completely in software/computer program products P and/or using a number of distributed physical devices.

1.-10. (canceled)

11. A method for signaling bearer channel modifications via a SIP protocol, comprising:
providing a protocol element for displaying a cause of the bearer modification.

12. The method according to claim 11, wherein the protocol element is located in a content disposition header field in accordance with the RFC2183 standard.

13. The method according to claim 12, wherein the protocol element is specified at least once.

14. The method according to claim 13, wherein the a value of the protocol element is selected from the group consisting of:
connect-backward, connect-forward, connect-forward-no-notification, connect-forward-plus-notification, connect-forward-no notification-plus-selected codec, connect-forward-plus-notification-plus-selected codec, connected, switched, selected-codec, modify-codec, successful-codec-modification, codec-modification-failure, mid-call-codec-negotiation, modify-to-selected-codec-information, mid-call-codec-negotiation-failure, redirect-backwards-request, redirect-forwards-request, redirect-bearer-release-request, proceed, redirect-bearer-release-complete, redirect-cut-through-request, redirect-bearer-connected-indication, redirect-failure, remote-hold, remote-hold-ack, remote-retrieval, remote-retrieval-ack, and combinations thereof.

15. The method according to claim 11, wherein the protocol element is embedded in an SDP protocol in accordance with a RFC2327 standard.

16. The method according to claim 15, wherein the protocol element is specified at least once.

17. The method according to claim 16, wherein the a value of the protocol element is selected from the group consisting of:
connect-backward, connect-forward, connect-forward-no-notification, connect-forward-plus-notification, connect-forward-no notification-plus-selected codec, connect-forward-plus-notification-plus-selected codec, connected, switched, selected-codec, modify-codec, successful-codec-modification, codec-modification-failure, mid-call-codec-negotiation, modify-to-selected-codec-information, mid-call-codec-negotiation-failure, redirect-backwards-request, redirect-forwards-request, redirect-bearer-release-request, proceed, redirect-bearer-release-complete, redirect-cut-through-request, redirect-bearer-connected-indication, redirect-failure, remote-hold, remote-hold-ack, remote-retrieval, remote-retrieval-ack, and combinations thereof.

18. The method according to claim 11, wherein the a value of the protocol element is selected from the group consisting of:
connect-backward, connect-forward, connect-forward-no-notification, connect-forward-plus-notification, connect-forward-no notification-plus-selected codec, connect-forward-plus-notification-plus-selected codec, connected, switched, selected-codec, modify-codec, successful-codec-modification, codec-modification-failure, mid-call-codec-negotiation, modify-to-selected-codec-information, mid-call-codec-negotiation-failure, redirect-backwards-request, redirect-forwards-request, redirect-bearer-release-request, proceed, redirect-bearer-release-complete, redirect-cut-through-request, redirect-bearer-connected-indication, redirect-failure, remote-hold, remote-hold-ack, remote-retrieval, remote-retrieval-ack, and combinations thereof.

19. The method according to claim 11, wherein the SIP protocol is embodied in accordance with the standard selected from the group consisting of:
RFC2542, RFC3261 and RFC3372.

20. A method for signaling bearer channel modifications in a communication network via a SIP protocol, comprising:
providing a protocol element for displaying a cause of the bearer modification, wherein the protocol element is specified at least once, wherein the protocol element is provided in a MIME message body of a SIP message embodied in accordance with a RFC 2045 standard.

21. The method according to claim 20, wherein the a value of the protocol element is selected from the group consisting of:
connect-backward, connect-forward, connect-forward-no-notification, connect-forward-plus-notification, connect-forward-no notification-plus-selected codec, connect-forward-plus-notification-plus-selected codec, connected, switched, selected-codec, modify-codec, successful-codec-modification, codec-modification-failure, mid-call-codec-negotiation, modify-to-selected-codec-information, mid-call-codec-negotiation-failure, redirect-backwards-request, redirect-forwards-request, redirect-bearer-release-request, proceed, redirect-bearer-release-complete, redirect-cut-through-request, redirect-bearer-connected-indication, redirect-failure, remote-hold, remote-hold-ack, remote-retrieval, remote-retrieval-ack, and combinations thereof

22. A device in a communications system for signaling a bearer channel modification, comprising:
a protocol element for displaying a cause of the bearer modification,
wherein the protocol element is specified at least once.

23. The device according to claim 22, wherein the a value of the protocol element is selected from the group consisting of:
connect-backward, connect-forward, connect-forward-no-notification, connect-forward-plus-notification, connect-forward-no notification-plus-selected codec, connect-forward-plus-notification-plus-selected codec, connected, switched, selected-codec, modify-codec, successful-codec-modification, codec-modification-failure, mid-call-codec-negotiation, modify-to-selected-codec-information, mid-call-codec-negotiation-failure, redirect-backwards-request, redirect-forwards-request, redirect-bearer-release-request, proceed, redirect-bearer-release-complete, redirect-cut-through-request, redirect-bearer-connected-indication, redirect-failure, remote-hold, remote-hold-ack, remote-retrieval, remote-retrieval-ack, and combinations thereof.

24. The device according to claim 23, wherein the protocol element is in a content disposition header field in accordance with a RFC2183 standard.

25. The device according to claim 23, wherein the protocol element is embedded in an SDP protocol in accordance with a RFC2327 standard.

26. The device according to claim 22, wherein the device is selected from the group consisting of:
media gateway controller, SIP telephone, and SIP proxy.
